(19) United States
(12) Patent Application Publication
(10) Pub. No.: US 2020/0153983 A1
(43) Pub. Date: May 14, 2020

(54) INFORMATION PROCESSING SYSTEM, INFORMATION PROCESSING APPARATUS, JOB CONTROL METHOD, AND JOB CONTROL PROGRAM

(71) Applicant: KONICA MINOLTA, INC., Tokyo (JP)

(72) Inventors: Kazumi SAWAYANAGI, Itami-shi (JP); Tomoaki NAKAJIMA, Kobe-shi (JP); Katsuhiko AKITA, Amagasaki-shi (JP); Toshikazu KAWAGUCHI, Kobe-shi (JP); Takashi OTSUKA, Kobe-shi (JP); Daisuke NAKANO, Kobe-shi (JP)

(73) Assignee: KONICA MINOLTA, INC., Tokyo (JP)

(21) Appl. No.: 16/654,409

(22) Filed: Oct. 16, 2019

(30) Foreign Application Priority Data
Nov. 9, 2018 (JP) 2018-211757

(51) Int. Cl. H04N 1/00; G06F 3/12

(52) U.S. Cl. CPC H04N 1/00403; H04N 2201/0094; G06F 3/1253; G06F 3/1204

(57) ABSTRACT

An information processing system includes a voice collecting device that collects a voice, and an information processing apparatus capable of generating a job, wherein either of the voice collecting device and the information processing apparatus includes a hardware processor that specifies a user who has uttered, and the hardware processor of the information processing apparatus generates, as the job, based on information obtained from a voice in which a first user and a second user are individually specified by the hardware processor, a request job that the first user has requested the second user to execute.

The entire disclosure of Japanese patent Application No. 2018-211757, filed on Nov. 9, 2018, is incorporated herein by reference in its entirety.

### BACKGROUND

### Technological Field

The present invention relates to an information processing system, an information processing apparatus, a job control method, and a job control program. In particular, the present invention relates to an information processing system including an information processing apparatus that generates a job from a voice, the information processing apparatus, a job control method executed by the information processing system, and a job control program that causes a computer to execute the job control method.

### Description of the Related art

In general, a multifunction peripheral (hereinafter referred to as “MFP”) is disposed in an office. A user causes the MFP to execute processes such as image data printing, document copying, document reading, image data storage, and image data transmission. There is a case where work for causing the MFP to execute a process is requested from one user to another user. In this case, the user who is requested for the work operates the MFP to perform the work. In order to execute the requested work, the user is required to perform settings for causing the MFP to execute a process corresponding to the work. If the user males a setting mistake, there is a case where work different from the requested work is performed.

For example, JP 2003-114779 A describes a setting processing device for an image forming apparatus. The setting processing device includes: means for a user to input a free word for any setting item; means that makes setting of a setting item in accordance with the inputted free word; and definition file generating and storing means that generates and stores a definition file in accordance with the set setting item.

However, according to the setting processing device described in JP 2003-114779 A, when one user verbally requests another user for work, the another user is required to re-enter the free word into the setting processing device on the basis of the request, causing a problem that the operation of the another user becomes complicated.

### SUMMARY

The present invention has been made to solve the above-described problem, and one of objects of the present invention is to provide an information processing system in which an operation for generating a job is simplified.

Another object of the present invention is to provide an information processing apparatus in which an operation for generating a job is simplified.

Still another object of the present invention is to provide a job control method in which an operation for generating a job is simplified.

Still another object of the present invention is to provide a job control program in which an operation for generating a job is simplified.

To achieve at least one of the abovementioned objects, according to an aspect of the present invention, an information processing system reflecting one aspect of the present invention comprises a voice collecting device that collects a voice; and an information processing apparatus capable of generating a job, wherein either of the voice collecting device and the information processing apparatus comprises a hardware processor that specifies a user who has uttered, and the hardware processor of the information processing apparatus generates, as the job, based on information obtained from a voice in which a first user and a second user are individually specified by the hardware processor, a request job that the first user has requested the second user to execute.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing an overall outline of an information processing system in a first embodiment of the present invention;

FIG. 2 is a block diagram showing an example of a hardware configuration outline of a PC in one embodiment;

FIG. 3 is a block diagram showing a hardware configuration outline of an MFP;

FIG. 4 is a block diagram showing an example of functions of a CPU provided in the PC;

FIG. 5 is a view showing an example of a keyword table;

FIG. 6 is a block diagram showing an example of functions of the CPU provided in the MFP;

FIG. 7 is a view showing an example of a login screen;

FIG. 8 is a flowchart showing an example of a flow of a job control process in the first embodiment;

FIG. 9 is a flowchart showing an example of a flow of a job generation process;

FIG. 10 is a flowchart showing an example of a flow of a job execution process;

FIG. 11 is a flowchart showing an example of a flow of an execution instruction process;

FIG. 12 is a flowchart showing an example of a flow of a job generation process in a first modification;

FIG. 13 is a block diagram showing an example of functions of a CPU provided in a PC in a second modification;

FIG. 14 is a flowchart showing an example of a flow of a job control process in the second modification;

FIG. 15 is a flowchart showing an example of a flow of a job generation process in the second modification;

FIG. 16 is a flowchart showing an example of a flow of a job execution process in the second modification;

FIG. 17 is a view showing an overall outline of an information processing system in a second embodiment of the present invention;

FIG. 18 is a block diagram showing an example of functions of a CPU provided in an MFP in the second embodiment; and

FIG. 19 is a block diagram showing an example of functions of a CPU provided in an MFP in a third modification

### DETAILED DESCRIPTION OF EMBODIMENTS

Hereinafter, one or more embodiments of the present invention will be described with reference to the drawings. However, the scope of the invention is not limited to the disclosed embodiments. In the following description, the same reference numerals are given to the same parts. Their names and functions are also the same. Therefore, detailed description thereof will not be repeated.

### First Embodiment

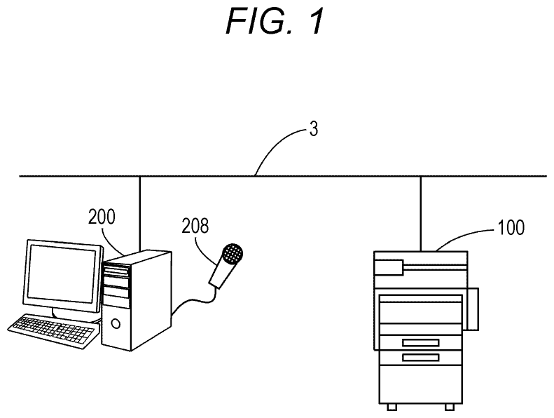

FIG. 1 is a view showing an overall outline of an information processing system in a first embodiment of the present invention. Referring to FIG. 1, an information processing system 1 includes a multi function peripheral (MFP) 100 and a personal computer (hereinafter referred to as “PC”) 200.

The MFP 100 is an example of an image forming apparatus. The PC 200 is an example of an information processing apparatus, and is a general computer. Each of the MFP 100 and the PC 200 is connected to a network 3. The network 3 is, for example, a local area network (LAN). Therefore, the MFP 100 and the PC 200 can communicate with each other via the network 3. For example, a printer driver program for controlling the MFP 100 is installed in the PC 200, and executing the printer driver program enables control of the MFP 100 to execute a print job. In the network 3, the connection form may be wired or wireless. Further, the network 3 may be a wide area network (WAN), a public switched telephone network (PSTN), the Internet, or the like.

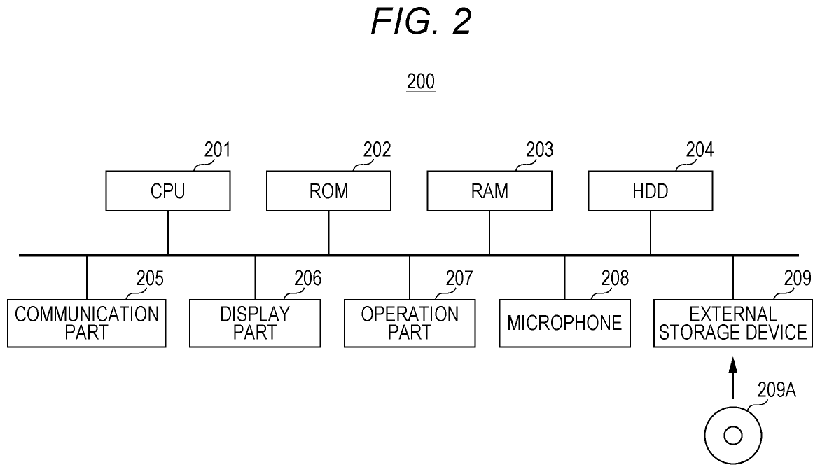

FIG. 2 is a block diagram showing an example of a hardware configuration outline of the PC in the present embodiment. Referring to FIG. 2, the PC 200 includes: a central processing part (CPU) 201 to control the entire PC 200; a read only memory (ROM) 202 to store a program to be executed by the CPU 201; a random access memory (RAM) 203 to be used as a work area of the CPU 201; a hard disk drive (HDD) 204 that stores data in a non-volatile manner; a communication part 205 that connects the CPU 201 to the network 3; a display part 206 that displays information; an operation part 207 that accepts an input of a user operation; a microphone 208; and an external storage device 209.

The CPU 201 downloads a program from a computer connected to the Internet and stores in the HDD 204. Further, when a computer connected to the network writes a program to the HDD 204, the program is stored in the HDD 204. The CPU 201 loads the program stored in the HDD 204 into the RAM 203 to execute.

As a software architecture of the CPU 201, an operating system (OS) layer is formed in the CPU 201, and an application layer is formed in a layer thereabove. To the OS layer, a task for the CPU 201 to execute an operating system (OS) program belongs. The task belonging to the OS layer executes processing for controlling hardware resources of the PC 200. Here, the hardware resources include the ROM 202, the RAM 203, the HDD 204, the communication part 205, the display part 206, the operation part 207, the microphone 208, and the external storage device 209. The task belonging to the OS layer controls the hardware resources in accordance with an operating command inputted from the application layer. To the application layer, a task for the CPU 201 to execute an application program belongs. In a case where a plurality of types of application programs are installed on the PC 200, a plurality of tasks that individually execute the plurality of types of application programs may belong to the application layer. Furthermore, on the basis of instructions from an operation user who operates the PC 200, the task for executing the application program specifies a process to be executed from a plurality of types of processes determined by the application program, and executes the process. The plurality of types of processes defined by the application program include at least a process of causing the MFP 100 to print data that is generated by the CPU 201 executing the application program.

The microphone 208 collects a voice, and converts the collected voice into an electrical signal. The microphone 208 outputs a voice signal converted from the voice to the electric signal, to a CPU 201.

The external storage device 209 is mounted with a compact disk read only memory (CD-ROM) 209A. In the present embodiment, an example will be described in which the CPU 201 executes a program stored in the ROM 202 or the HDD 204. However, the CPU 201 may control the external storage device 209 to read the program to be executed by the CPU 201 from the CD-ROM 209A, and store the read program into the RAM 203 to execute.

A recording medium that stores the program to be executed by the CPU 201 is not limited to the CD-ROM 209A, but may be a flexible disk, a cassette tape, an optical disk (magnetic optical disc (MO)/mini disc (MD)/digital versatile disc (DVD)), an IC card, an optical card, or a semiconductor memory such as a mask ROM, or an erasable programmable ROM (EPROM), and the like. The program herein includes a source program, a compressed program, an encrypted program, and the like, in addition to a program directly executable by the CPU 201.

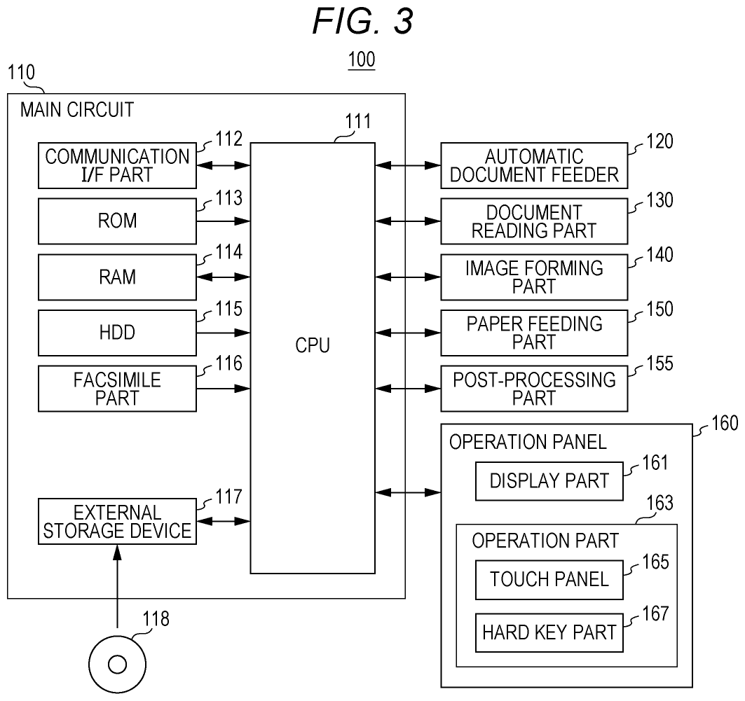

FIG. 3 is a block diagram showing a hardware configuration outline of the MFP. Referring to FIG. 3, the MFP 100 includes: a main circuit 110; a document reading part 130 to read a document; an automatic document feeder 120 to convey the document to the document reading part 130; an image forming part 140 to form an image on paper or the like on the basis of image data read and outputted by the document reading part 130; a paper feeding part 150 to feed paper to the image forming part 140; a post-processing part 155 to process a paper formed with the image; and an operation panel 160 as a user interface.

The post-processing part 155 executes a sorting process of rearranging and discharging one or more pieces of paper on which an image is formed by the image forming part 140, a punching process of punching holes, and a stapling process of driving a staple.

The main circuit 110 includes a CPU 111, a communication interface (I/F) part 112, a ROM 113, a RAM 114, a hard disk drive (HDD) 115 as a mass storage device, a facsimile part 116, and an external storage device 117 mounted with a CD-ROM 118. The CPU 111 is connected to the automatic document feeder 120, the document reading part 130, the image forming part 140, the paper feeding part 150, the post-processing part 155, and the operation panel 160, and controls the entire MFP 100.

The ROM 113 stores a program executed by the CPU 111 or data necessary for executing the program. The RAM 114 is used as a work area when the CPU 111 executes a program. Further, the RAM 114 temporarily stores a read data (image data) continuously sent from the document reading part 130.

The communication I/F part 112 is an interface to connect the MFP 100 to the network 3. The CPU 111 communicates between with the PC 200 via the communication I/F part 112 to transmit and receive data. Further, the communication I/F part 112 can communicate with a computer connected to the Internet 5 via the network 3.

The facsimile part 116 is connected to the public switched telephone network (PSTN) to transmit facsimile data to the PSTN or receive facsimile data from the PSTN. The facsimile part 116 stores the received facsimile data into the HDD 115 or outputs the facsimile data to the image forming part 140. The image forming part 140 prints the facsimile data received by the facsimile part 116 on paper. Further, the facsimile part 116 converts the data stored in the HDD 115 into facsimile data, to transmit the facsimile data to a facsimile machine connected to the PSTN.

The external storage device 117 is mounted with the compact disk ROM (CD-ROM) 118. The CPU 111 can access the CD-ROM 118 via the external storage device 117. The CPU 111 loads a program recorded in the CD-ROM 118 mounted to the external storage device 117 into the RAM 114, to execute the program. A medium that stores the program to be executed by the CPU 111 is not limited to the CD-ROM 118, but may be an optical disk (magnetic optical disc (MO)/mini disc (MD)/digital versatile disc (DVD)), an IC card, an optical card, or a semiconductor memory such as a mask ROM, or an erasable programmable ROM (EPROM).

In addition, the program executed by the CPU 111 is not limited to the program recorded in the CD-ROM 118, and the program stored in the HDD 115 may be loaded into the RAM 114 to be executed. In this case, another computer connected to the network 3 may rewrite the program stored in the HDD 115 of the MFP 100, or add and write a new program. Further, the MFP 100 may download a program from another computer connected to the network 3, and store the program into the HDD 115. The program herein includes a source program, a compressed program, an encrypted program, and the like, in addition to a program directly executable by the CPU 111.

The operation panel 160 is provided on an upper surface of the MFP 100, and includes a display part 161 and an operation part 163. The display part 161 is, for example, a liquid crystal display (LCD) or organic electroluminescence (LE) display, and displays an instruction menu for a user, information on obtained image data, and the like. The operation part 163 includes a touch panel 165 and a hard key part 167. The touch panel 165 is provided to be superimposed on the display part 161 on an upper surface or a lower surface of the display part 161. The hard key part 167 includes a plurality of hard keys. The hard key is, for example, a contact switch. The touch panel 165 detects a position instructed by a user on a display surface of the display part 161. Since a user is often in an upright posture when operating the MFP 100, the display surface of the display part 161, an operation surface of the touch panel 165, and the hard key part 167 are arranged facing upward. This is to allow the user to easily view the display surface of the display part 161 and easily instruct the operation part 163 with the user's fingers.

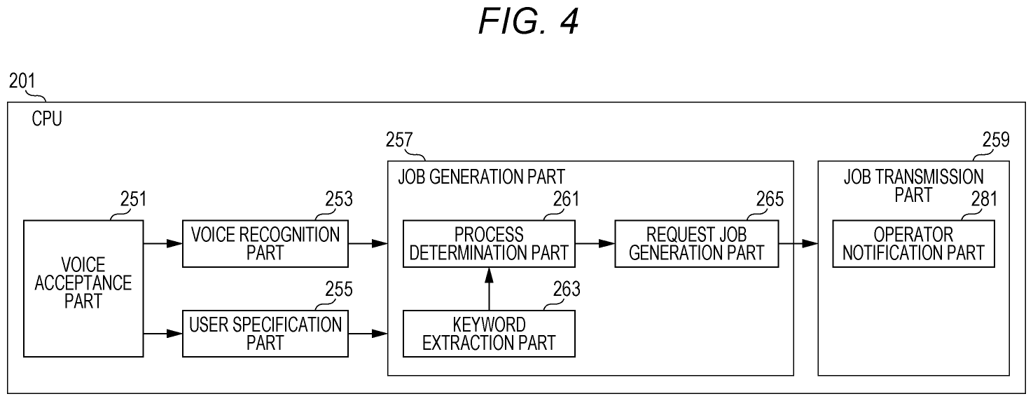

FIG. 4 is a block diagram showing an example of functions of the CPU 201 provided in the PC 200. The functions shown in FIG. 4 may be realized by hardware, or may be realized by the CPU 201 by causing the CPU 201 provided in the PC 200 to execute a program stored in the ROM 202, the HDD 204, or the CD-ROM 209A. Here, a case where the CPU 201 provided in the PC 200 executes a job generation program will be described as an example.

Referring to FIG. 4, the CPU 201 provided in the PC 200 includes a voice acceptance part 251, a voice recognition part 253, a user specification part 255, a job generation part 257, and a job transmission part 259. The voice acceptance part 251 accepts a voice signal outputted from the microphone 208. The voice acceptance part 251 outputs the voice signal inputted from the microphone 208 and time information indicating a time at which the voice signal is inputted, to the voice recognition part 253 and the user specification part 255.

Exclusively while the user is uttering, the voice signal is inputted from the microphone 208. When a plurality of users have a conversation, a voice signal of voices uttered by one user and another user may be inputted to the voice acceptance part 251 in some cases. In addition, a period during which one user utters may be different from a period during which another user utters, in some cases. In this case, a voice signal of a voice uttered by one user mid a voice signal of a voice uttered by another user are inputted to the voice acceptance part 251 in different periods. Further, when one user utters intermittently, a voice signal of a previous voice and the next voice signal are inputted to the voice acceptance part 251 in different periods.

Each time the voice signal and the time information are inputted from the voice acceptance part 251, the voice recognition part 253 recognizes the voice specified by the voice signal. Specifically, the voice recognition part 253 converts the voice signal into character information. Since the technique for recognizing a voice is publicly known, the description will not be repeated here. The voice recognition part 253 outputs a set of the character information converted from the voice signal and the time information, to the job generation part 257. When voices of a plurality of users are included in the voice signal, the voice recognition part 253 divides the voice signal into voice signals for each of the plurality of users, and recognizes the voice for each of the plurality of voice signals. In this case, the voice recognition part 253 outputs a set of the voice signal, the character information, and the time information, to the user specification part 255 for each of the plurality of voice signals.

Each time the voice signal and the time information are inputted from the voice acceptance part 251, the user specification part 255 specifies a user who has uttered the voice specified by the voice signal. Specifically, the HDD 204 stores voice print information indicating a voice print of each of a plurality of users registered in advance. The user specification part 255 specifies the user by comparing the voice specified by the voice signal inputted from the voice acceptance part 251 with each of the voice prints of the plurality of users. In addition, since the technique for specifying the user who has uttered the voice is publicly known, the description will not be repeated here. The user specification part 255 outputs a set of user identification information for identifying the specified user and time information, to the job generation part 257. When the set of the voice signal, the character information, and the time information is inputted from the voice recognition part 253, the user specification part 255 specifies the user who has uttered the voice specified by the voice signal. The user specification part 255 outputs a set of the user identification information for identifying the specified user, the time information, and the character information, to the job generation part 257.

The job generation part 257 is inputted with a set of character information and time information from the voice recognition part 253, and inputted with a set of user identification information and time information from the user specification part 255. The job generation part 257 mutually associates user identification information and character information each being in a set with same time information. In other words, the job generation part 257 associates a voice with a user who has uttered the voice. Specifically, the job generation part 257 generates voice information including character information converted from a voice and user identification information of a user who has uttered the voice. The job generation part 257 may be inputted with a plurality of sets of character information and time information and a plurality of sets of user identification information and time information. The job generation part 257 uses time information to distinguish a plurality of pieces of voice information. Specifically, the job generation part 257 generates a voice set including voice information and time information. The job generation part 257 generates a job on the basis of one or more voice sets. When a set of user identification information, time information, and character information is inputted from the user specification part 255, the job generation part 257 generates voice information including the character information and the user identification information included in the set, and, generates a voice set including the voice information and, the time information.

The job generation part 257 includes a process determination part 261, a keyword extraction part 263, and a request job generation part 265. The keyword extraction part 263 extracts a keyword from the character information of the voice information. As processing-related information in which a keyword is associated with a process that can be executed by the MFP 100, a keyword table is stored in the HDD 204. The keyword extraction part 263 extracts any of one or more keywords defined in the keyword table from the character information. The keyword extraction part 263 may extract a plurality of keywords from one piece of the character information, and may not extract a keyword from one piece of the character information, in some cases. Further, in a case where there are a plurality of pieces of voice information having different time information, the keyword, extraction part 263 extracts one or more keywords from the character information included, in the voice information for each of the plurality of pieces of voice information. The keyword extraction part 263 outputs a set of the keyword extracted from the character information and the user identification information associated with the character information, to the process determination part 261. When extracting one or more keywords from one or more pieces of character information, the keyword extraction part 263 outputs, for each of the extracted one or more keywords, a set of the keyword and the user identification information to the process determination part 261.

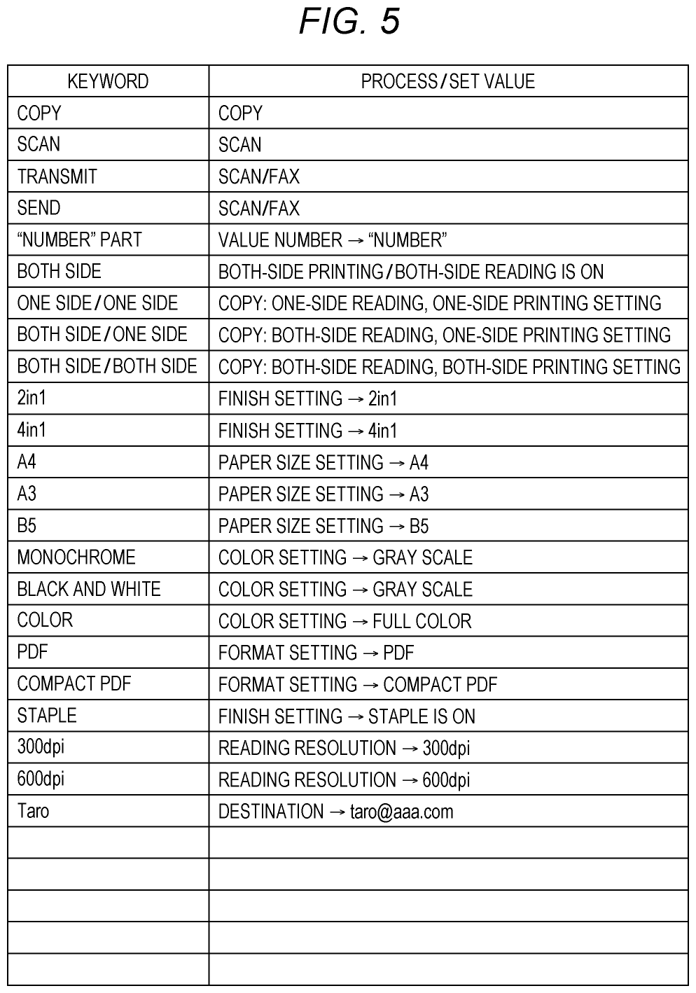

FIG. 5 is a view showing an example of the keyword table. The keyword table includes a plurality of keyword records that associate keywords with processes to be executed by the MFP 100 or with set values for specifying a process to be executed by the MFP 100. The keyword record includes a keyword item and a process/set value item. In the keyword record, a keyword is set in the keyword item, and a process name or a set value is set in the process/set value item. As an example of the keyword table associating a keyword with a process to be executed by the MFP 100, a keyword record including a keyword “scan” associates the keyword “scan” with a sea process of causing the MFP 100 to read a document. Further, a keyword record including a keyword “2 in 1” associates the keyword “2 in 1” with a 2 in 1 process of synthesizing two pages of images. The keyword table may associate a plurality of processes with one keyword. For example, a keyword record including a keyword “copy” associates a copy process with the keyword “copy”. The copy process includes a scan process of causing the MFP 100 to read a document and a print process of forming an image on paper.

As an example of the keyword table associating a keyword with a set value that specifies a process to be executed by the MFP 100, full color is associated with a keyword “color” as a set value of a process to be executed by the MFP 100. Further, as another example, a keyword “user name” is associated with a destination of a user having the user name, as a set value of a process to be executed by the MFP 100. Note that a keyword “Taro” indicates a name of a user registered in advance. The destination is an e-mail address registered in advance for the user whose name is “Taro”.

Returning to FIG. 4, the process determination part 261 generates a job in which a process to be executed by the MFP 100 is defined on the basis of one or more sets of a keyword and user identification information. The process determination part 261 specifies a process or a set value associated with each of one or more keywords inputted from the keyword extraction part 263, and generates a job that causes the MFP 100 to execute the specified process with the specified set value. For example, when the keywords “copy” and “full color” are inputted, a scan process and a print process associated with the keyword “copy” are specified, and a set value of full color associated with the keyword “full color” is specified. In this case, the process determination part 261 generates a copy job that causes the MFP 100 to execute a scan process of reading a document in full color and a print process of funning, on paper, an image of full-color image data that is outputted when the scan process is executed. Further, when the keywords “send” and “Taro” are inputted, a scan process and a facsimile transmission process associated with the keyword “send” are specified, and a set value of a destination associated with the keyword “Taro” is specified. In this case, the process determination part 261 generates a facsimile transmission job that causes the MFP 100 to execute a scan process of reading a document in monochrome, and a facsimile transmission process of performing facsimile transmission of monochrome image data outputted when the scan process is executed, to a facsimile number registered for the user whose name is Taro.

When generating a job, the process determination part 261 determines one or more pieces of user identification information in a set individually with one or more keywords used for generating the job. For example, when a job is generated on the basis of one or more keywords in a set with user identification information of a first user, the user identification information of the first user is determined. When a job is generated on the basis of one or more keywords in a set with the user identification information of the first user and one or more keywords in a set with user identification information of a second user, the user identification information of the first user and the user identification information of the second user are determined. The process determination part 261 outputs a set of the job and the determined one or more pieces of user identification information, to the request job generation part 265.

The request job generation part 265 is inputted with a job from the process determination part 261, and generates a request job on the basis of one or more voice sets. The request job is a job that the second user causes the MFP 100 to execute in order for the second user to execute an operation requested by the first user who is a requester to the second user who is an approver. In other words, the request job is a job that the second user instructs the MFP 100 to execute. Therefore, the request job is a job in which an instruction by the second user is set as a start condition for the MFP 100 to execute a process determined by the job, in the job inputted from the process determination part 261.

The request job generation part 265 generates a request job in a case where there are a plurality of pieces of user identification information individually included in one or more pieces of voice information, and there is character information including a request character string in one or more pieces of the character information inputted from the voice recognition part 253. The request character string includes a word used in requesting another person for work. For example, the request character string includes “please”, “do”, “perform”, and the like. The request character string may be determined in advance. Alternatively, the CPU 201 may be made to determine the request character string by causing the CPU 201 to learn conversations between a plurality of users who use the MFP 100.

However, the request job generation part 265 does not generate a request job when there is no character information including an approval character string among one or more pieces of character information inputted from the voice recognition part 253. The approval character string includes a word used in accepting a request from another person. The approval character string includes “OK”, “understand”, “accept”, and the like. The approval character string may be determined in advance. Alternatively, the determination may be made by causing the CPU 201 to learn conversations between a plurality of users who use the MFP 100.

When there is character information including a request character string, the request job generation part 265 specifies user identification information in a set with the character information, as the user identification information of the first user. Further, when there is character information including an approval character string, the request job generation part 265 specifies user identification information in a set with the character information, as the user identification information of the second user. The request job generation part 265 generates a request job by setting, as a start condition for the MFP 100 to execute the process defined by the job, reception of an instruction from the second user, in the job inputted from the process determination part 261. The request job generation part 265 outputs a set of the user identification information of the first user and the request job, to the job transmission part 259.

When there is character information including an approval character string, the request job generation part 265 determines voice information in a set with time information indicating a time before a time indicated by time information in a set with voice information including the character information. Then, the request job generation part 265 extracts character information including a request character string from character information included in the determined voice information. As a result, since a request job may simply be generated when there is character information including an approval character string, it is not necessary to extract keywords from all character information, which can reduce the load as much as possible. In this case, it is desirable to start the keyword extraction by the keyword extraction part 263 and the job generation by the process determination part 261 after confirmation of the presence of the character information including the approval character string.

The job transmission part 259 transmits a job to the MFP 100. When a set of a request job and the user identification information of the first user is inputted from the request job generation part 265, the job transmission part 259 transmits the set of the request job and the user identification information of the first user to the MFP 100. In addition, when a normal job is inputted from a normal job generation part 267, the job transmission part 259 transmits the normal job to the MFP 100.

The job transmission part 259 includes an operator notification part 281. When the set of the request job and the user identification information of the first user is transmitted to the MFP 100, the operator notification part 281 notifies the second user that the request job can be executed with the MFP 100. The second user is specified with user identification information of the second user that has been set as the start condition in the request job. For example, the operator notification part 281 controls the communication part 205 to transmit, to the second user, an e-mail including a message indicating the presence of the executable request job in the MFP 100. The e-mail address of the second user is stored in advance. Moreover, the notification method is not limited to the e-mail, but may be message transmission. This enables notification to the second user that it is only required to input an operation for causing the MFP 100 to execute the request job.

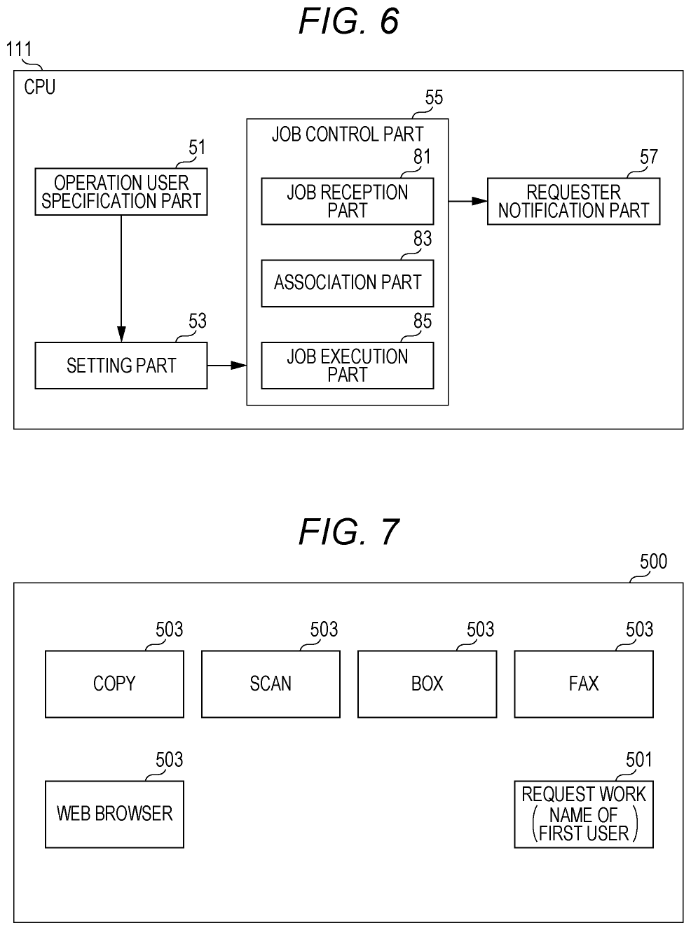

FIG. 6 is a block diagram showing an example of functions of the CPU 111 provided in the MFP 100. The functions shown in FIG. 6 may be realized by hardware, and are functions realized by the CPU 111 provided in the MFP 100, by the CPU 111 executing a job execution program stored in the ROM 113, the HDD 115, or the CD-ROM 118. The job execution program is a part of a job control program. Referring to FIG. 6, the CPU 111 includes an operation user specification part 51, a setting part 53, a job control part 55, and a requester notification part 57.

The job control part 55 includes a job reception part 81, an association part 83, and a job execution part 85. The job reception part 81 controls the communication I/F part 112, and receives a job transmitted from the PC 200. When receiving a set of a request job and the user identification information of the first user from the PC 200, the job reception part 81 stores the request job in the HDD 115. Further, when receiving a normal job from the PC 200, the job reception part 81 stores the normal job in the HDD 115.

When the communication I/F part 112 receives a set of a request job and the user identification information of the first user from the PC 200, the association part 83 associates the request job with the first user. Specifically, the association part 83 generates a user record including job identification information for identifying the request job stored in the HDD 115 and the user identification information of the first user, and stores in the HDD 115.

The job execution part 85 executes a job by controlling hardware resources. The hardware resources include the communication I/F part 112, the HDD 115, the facsimile part 116, the automatic document feeder 120, the document reading part 130, the image forming part 140, the paper feeding part 150, the post-processing part 155, and the operation panel 160. The job includes, for example, a copy job, a print job, a scan job, a facsimile transmission job, and a data transmission job. Note that jobs that can be executed by the job execution part 85 are not limited to these, and may include other jobs. The copy job includes a scan process of causing the document reading part 130 to read a document, and a print process of causing the image forming part 140 to form an image of data outputted by the document reading part 130 after reading the document. The print job includes a print process of causing the in forming part 140 to form, on paper, an image of data stored in the HDD 115 and of print data received from outside by the communication I/F part 112. The scan job includes a scan process of causing the document reading part 130 to read a document, and an output process of outputting image data outputted by the document reading part 130 after reading the document. The output process includes a data storage process of storing data in the HDD 115, and data transmission process of externally transmitting data by the communication I/F part 112. The facsimile transmission job includes a scan process of causing the document reading part 130 to read a document, and a facsimile transmission process of causing the facsimile part 116 to transmit data outputted by the document reading part 130 after reading the document. The data transmission job includes a data transmission process of controlling the communication I/F part 112 to transmit, to another computer, data stored in the HDD 115 or data outputted by the document reading part 130 after reading the document.

The operation user specification part 51 specifies an operation user who operates the MFP 100. For example, in a case where a user operates the operation panel 160, when the user inputs user identification information to the operation part 163, a user identified by the user identification information inputted to the operation part 163 is specified as the operation user. Further, in a case where the MFP 100 is provided with a card reader, the operation user specification part 51 accepts an operation of the user to cause the card reader to read user identification information stored in the card when the card reader reads the user identification information stored on the card. The operation user specification part 51 specifies, as an operation user, a user identified by the user identification information read by the card reader. The card reader may be a magnetic card reader or a wireless communication device that communicates in accordance with near field communication (NFC) standards. When specifying the operation user, the operation user specification part 51 outputs the user identification information of the operation user to the setting part 53.

When the user identification information of the operation user is inputted from the operation user specification part 51, the setting part 53 determines whether or not the HDD 115 stores a request job or a normal job in which an instruction by the user of the user identification information is set as a start condition. When such a request job or normal job is stored in the HDD 115, the setting part 53 sets the request job or normal job to an executable state. Specifically, the setting part 53 displays a setting button for accepting an instruction from the user, on the display part 161. A command for executing the request job or the normal job is assigned to the setting button.

FIG. 7 is a view showing an example of a login screen. A login screen 500 shown in FIG. 7 is displayed on the display part 161 when the second user operates the operation part 163, and the user is specified by the MFP 100. Referring to FIG. 7, the login screen 500 includes a plurality of selection buttons 503 for selecting various processes, and a setting button 501. The setting button 501 is displayed when the second user operates the operation part 163, and the second user is specified by the MFP 100. Therefore, when the request job is not stored in the HDD 115, the login screen 500 does not include the setting button 501. The setting button 501 includes a character string “work request” and a character string “(Mr./Ms. xx)”. The character string “(Mr./Ms. XX)” is user identification information of the first user. Therefore, the second user who sees the setting button 501 can recognize that the setting button 501 is a button for setting an executable state of a request job for performing the work requested by the first user.

Returning to FIG. 6, instead of displaying the setting button 501 on the display part 161, the setting part 53 can selectably display job identification information for identifying one or more jobs stored in the HDD 115, on the display part 161. In this case, when the request job is stored in the HDD 115, the job identification information of the request job is selectably displayed on the display part 161. When the user selects the job identification information of the request job, the setting part 53 sets the request job to an executable state similarly to when the setting button is instructed.

The setting part 53 changes a set value of the job when accepting an operation for changing the set value of the job that has been set to be executable. This allows the second user to change a set value erroneously set in the request job to a correct value, and to additionally set an unset set value.

Further, there is a case where a predetermined time elapses alter the request job in which an instruction from the second user is set as a start condition is stored in the HDD 115 without being, executed, in this case, the setting part 53 does not set the request job to an executable state even when the user identification information of the second user is inputted from the operation user specification part 51. Specifically, the setting part 53 does not display, on the display part 161, the setting button 501 for accepting an instruction, from the user, for executing the request job. This is to eliminate a state where a request job that is no longer necessary is stored in the HDD 115, while there is a high probability that the execution of the request job is no longer necessary if the request job has not been executed even after a predetermined time. By deleting unnecessary data, storage resources can be used effectively.

The job execution part 85 included in the job control part 55 executes the request job when accepting a request job execution instruction operation to be inputted to the operation part 163 by the second user. In addition, when accepting a normal job execution instruction operation inputted to the operation part 163 by the first user, the job execution part 85 executes the normal job.

The requester notification part 57 notifies the first user that the request job has been executed, in response to the execution of the request job. The first user is specified with the user identification information associated with the job identification information of the request job by the association part 83. The requester notification part 57 notifies the first user that the request job has been executed by a method registered in advance. For example, the requester notification part 57 transmits, by an e-mail, a message indicating that the request job has been executed by the second user, to a destination registered in advance for the first user.

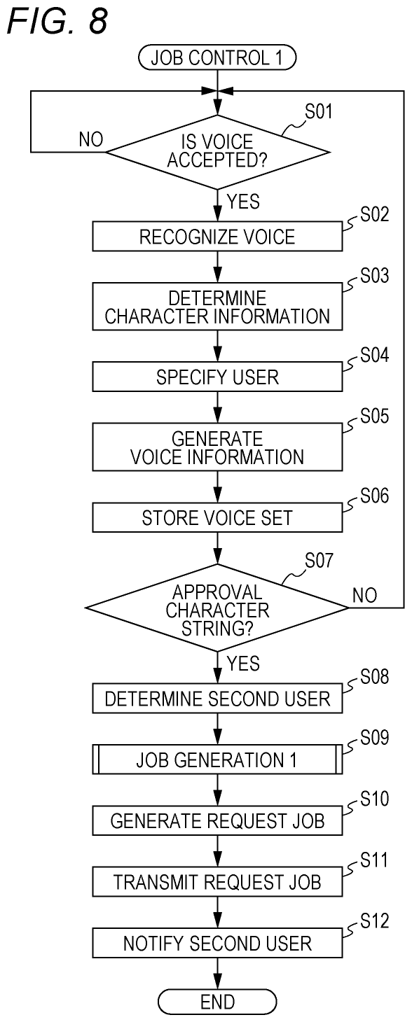

FIG. 8 is a flowchart showing an example of a flow of a job control process in the first embodiment. The job control process is a process executed by the CPU 201 provided in the PC 200, by the CPU 201 executing a job control program stored in the ROM 202, the HDD 204, or the CD-ROM 209A.

Referring to FIG. 8, the CPU 201 provided in the PC 200 determines whether or not a voice has been accepted. Specifically, the CPU 201 determines that a voice has been accepted when receiving a voice signal outputted from the microphone 208. The CPU 201 is in a standby state until a voice signal is accepted from the microphone 208 (NO in step S01), and the processing proceeds to step S02 when a voice signal is accepted (YES in step S01).

In step S02, voice recognition is performed, and the processing proceeds to step S03. The voice specified with the voice signal accepted in step S01 is subjected to the voice recognition, and the voice is converted into information composed of characters. In step S03, the information converted from the voice and composed of characters is determined as character information, and the processing proceeds to step S04.

In step S04, a user who has uttered the voice specified by the voice signal is specified, and the processing proceeds to step S05. Using the voice print information stored in the HDD 204, the voice specified with the voice signal is compared with each of voice prints of a plurality of users, to specify the user. The voiceprint information is information indicating a voiceprint of each of the plurality of users registered in advance. In step S05, the CPU 201 generates voice information and advances the process to step S06. Specifically, the CPU 201 generates voice information including the character information determined in step S03 and including tile user identification information specified in step S04. The voice information is information including character information converted from a voice and including user identification information of the user who has uttered the voice.

In step S06, a voice set is stored in the HDD 115, and the processing proceeds to step S07. Specifically, a voice set is generated including the voice information generated in step S05 and time information indicating a time at which the voice has been accepted in step S01, and the voice set is stored in the HDD 115. The voice set includes voice information and time information indicating a time at which the voice has been uttered.

In step S07, it is determined whether or not the character information includes an approval character string. The approval character string is a character string including a word used in accepting a request from another person, and is determined in advance. Specifically, the approval character string includes “OK”, “understand”, “accept”, and the like. When the character information determined in step S03 includes an approval character string, the processing proceeds to step S08, otherwise the processing returns to step S01.

In step S08, the user specified in step S04 is determined as tile second user, and the processing proceeds to step S09. The second user is a user who approves a request for work from the first user.

In step S09, a job generation process is executed, and the processing proceeds to step S10. While details of the job generation process will be described later, the job generation process is a process of generating a job on the basis of one or more voice sets stored in the HDD 115, and determining the first user who has requested the second user for work. In step S10, a request job is generated, and the processing proceeds to step S11. The request job is generated on the basis of the job generated by executing the job generation process, and the second user determined in step S08. The request job is a job in which acceptance of an operation by the second user is set as a start condition for causing the MFP 100 to execute a process determined by the request job. Specifically, the request job is generated by setting, in the job generated in step S09, acceptance of an operation by the second user determined in step S08 as a start condition. In the next step S11, the communication part 205 is controlled to transmit the request job to the MFP 100, and the processing proceeds to step S12. In step S12, the second user is notified of the presence of the request job, and the processing is ended. Specifically, there is generated an e-mail including a message indicating the presence of a request job that can be executed in the MFP 100 and having the second user's e-mail address so as a destination address, and the communication part 205 is caused to transmit the e-mail.

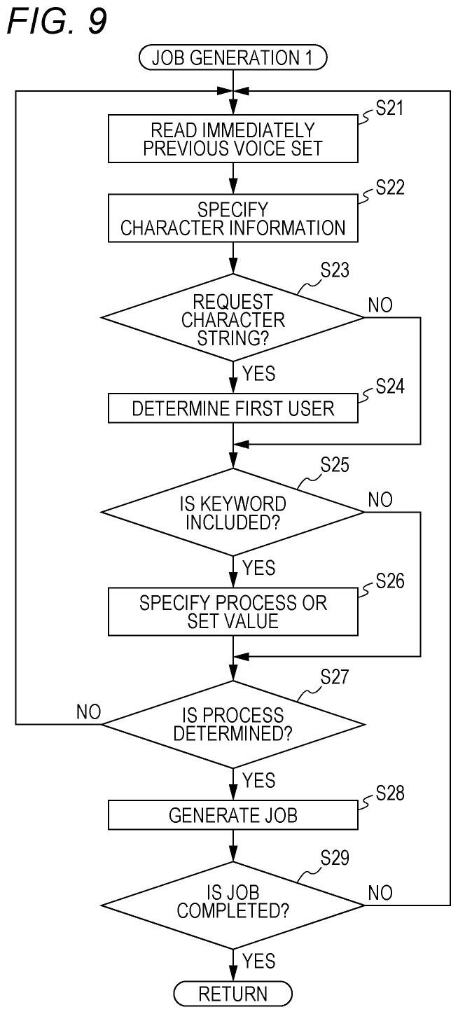

FIG. 9 is a flowchart showing an example of a flow of the job generation process. The job generation process is a process executed in step S09 in FIG. 8. In step S06 before the job generation process is executed, a voice set including character information including an approval character string is stored in the HDD 115. Hereinafter, a voice set including character information including an approval character string is referred to as a processing target set.

Referring to FIG. 9, the CPU 201 reads a voice set at an immediately previous time (step S21). Specifically, a voice set including time information indicating the closest time before a time indicated by time information included in the processing target set is read from the plurality of voice sets stored in the HDD 115. In the next step S22, character information included in the voice information included in the voice set is specified.

Then it is determined whether or not the character information includes a request character string (step S23). The request character string includes a word used in requesting another person for work. For example, the request character string includes “please”, “do”, “perform”, and the like. The request character string may be determined in advance. When the character information includes a request character string, the processing proceeds to step S24, otherwise step S24 is skipped and the processing proceeds to step S25. In step S24, the user who has uttered the request character string is determined as the first user, and the processing proceeds to step S25. The user specified with the user identification information included in the voice information included in the voice set read in step S21 is determined as the first user.

In step S25, it is determined whether or not the character information includes a keyword. When the character information includes a keyword, the processing proceeds to step S26, otherwise step S26 is skipped and the processing proceeds to step S27. In step S26, a process or a set value corresponding to the keyword included, in the character information is specified, and the processing proceeds to step S27. In step S27, it is determined whether or not the process is determined on the basis of the process or the set value specified in step S24. When the process is determined, the processing proceeds to step S28, otherwise the processing returns to step S21.

In step S28, a job for causing the MFP 100 to execute the process determined in step S27 is generated, and the processing proceeds to step S29. In step S29, it is determined whether or not the job is completed. There is a case where the job defines a plurality of processes, and it is determined that the job is completed when all of the plurality of processes are defined. When the job is completed, the processing returns to the job control process, otherwise the processing returns to step S21.

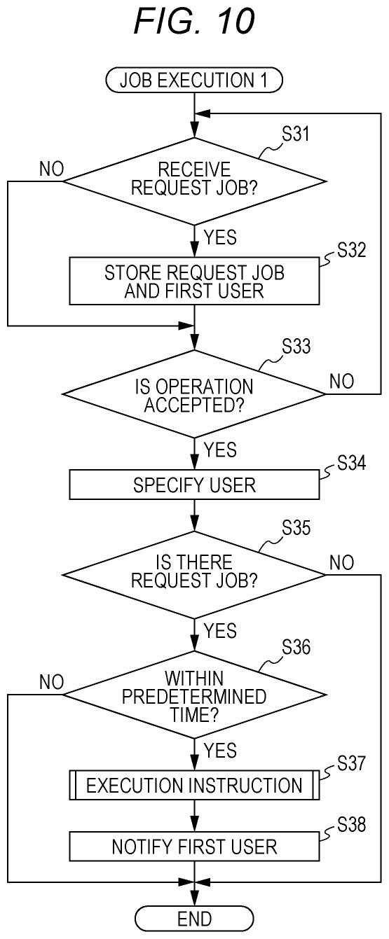

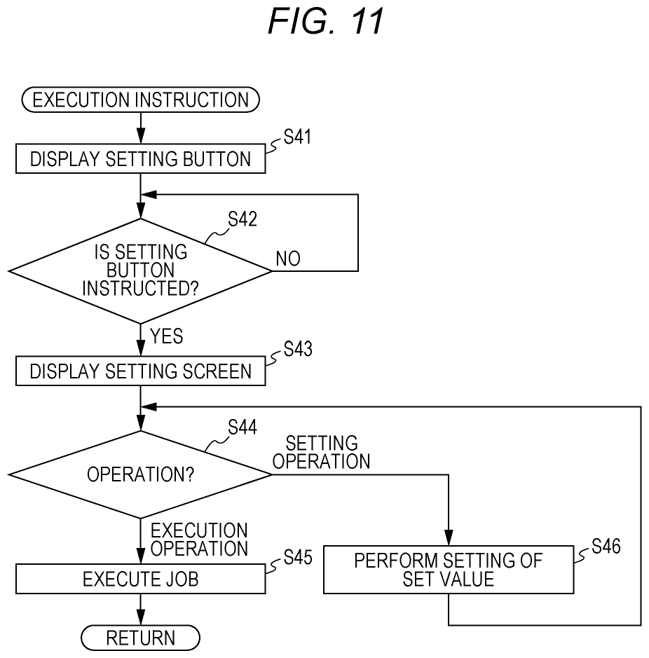

FIG. 10 is a flowchart showing an example of a flow of a job execution process. The job execution process is a function realized by the CPU lit provided in the MFP 100, by the CPU 111 executing, the job execution program stored in the ROM 113, the HDD 115, or the CD-ROM 118. The job execution program is a part of the job control program. Referring to FIG. 10, the CPU 111 provided in the MFP 100 determines whether or not a request job has been received (step S31). The CPU 111 controls the communication I/F part 112 to determine whether or not a request job and user identification information of the first user are received from the PC 200. When the request job has been received, the processing proceeds to step S32, otherwise the processing proceeds to step S33. In step S32, the request job and the user identification information of the first user received together with the request job are stored in the HDD 115, and the processing proceeds to step S33.

In step S33, it is determined whether or not the operation part 163 has accepted an operation inputted by the user. When the operation has been accepted, the processing proceeds to step S34, otherwise the processing returns to step S31. In step S34, the user who operates the operation part 163 is specified, and the processing proceeds to step S35. When the user inputs user identification information to the operation part 163, the user identified by the user identification information inputted to the operation part 163 is specified as the operation user. Further an operation of the user to cause a card reader to read user identification information stored in the card is accepted, and the user identified by the user identification information read by the card reader is specified as the operation user.

In step S35, it is determined whether or not there is a request job corresponding to the specified user. It is determined whether or not the HDD 115 stores a request job in which an instruction by the specified user is set as a start condition. When the request job is present, the processing proceeds to step S36, otherwise the processing is ended.

In step S36, it is determined whether or not an elapsed time since the request job has been received is within a predetermined time. When it is within the predetermined time, the processing proceeds to step S37. When the predetermined time has elapsed, the processing is ended. In a case where a predetermined time has passed since the request job has been received, there is a high probability that the request job is no longer necessary. Therefore, it is possible to inhibit execution of a request job that is no longer necessary.

In step S37, an execution instruction process is executed, and the processing proceeds to step S38. Details of the execution instruction process will be described later. In step S38, the first user is notified that the request job has been executed, and the processing is ended. The first user is specified using the user identification information stored in the HDD 115 in step S32 together with the request job specified in step S35. For example, there is generated an e-mail including a message indicating that the request job has been executed by the second user and including the e-mail address of the first user as a destination, and the e-mail is transmitted by controlling the communication I/F part 112.

FIG. 11 is a flowchart showing an example of a flow of the execution instruction process. The execution instruction process is a process executed in step S37 of FIG. 10. The request job is determined at a stage before the execution instruction process is executed. Referring to FIG. 11, the CPU 111 displays a setting button on the display part 161, and the processing proceeds to step S42. The setting button is a button for accepting an operation for setting a request job to an executable state, and is associated with a command for setting the request job to the executable state. In step S42, it is determined whether or not the setting button has been instructed. The processing is in a standby state until the setting button is instructed (NO in step S42), and when the setting button is instructed (YES in step S42), the processing proceeds to step S43. In step S43, a setting screen for setting a set value of the request job is displayed, and the processing proceeds to step S44. In step S44, the processing is branched, depending on time operation inputted by the user. When the operation inputted by the user is an execution operation, the processing proceeds to step S45. When the operation is a setting operation, the processing proceeds to step S46. The execution operation is an operation for instructing execution of the request job. The setting operation is an operation for setting a set value of the request job. In step S46, a set value is set in accordance with the setting operation, and the processing returns to step S44. In step S45, the request job is executed, and the processing returns to the job execution process.

<First Modification>

The request job generation part 265 determines, as character information to be used for generating a request job, character information included in voice information in a set with time information indicating a time before a time indicated by time information in a set with voice information including character information including an approval character string. In this case, the request job generation part 265 may set character information including a name of the second user, as character information with the earliest time indicated by the time information among the character information to be used for generating the request job. A name to be used for each user may be registered in advance. When the first user requests the second user for work, the work is often requested after uttering the name of the second user. Therefore, the character information used for generating the request job can be narrowed down on the basis of the time information. Accordingly, the number of pieces of character information to be processed can he reduced as much as possible, and the load on the CPU 201 can be reduced.

Note that there is case where the request job generation part 265 is not able to generate a request job on the basis exclusively of a plurality of pieces of character information corresponding a time between a time corresponding to the text information including the name of the second user and a time corresponding to the character information including the approval character string. In this case, the request job generation part 265 generates the request job by using character information included in voice information that is in a set with time information indicating a time before a time indicated, by time information hi a set with the voice information including the character information including time name to be used of the second user.

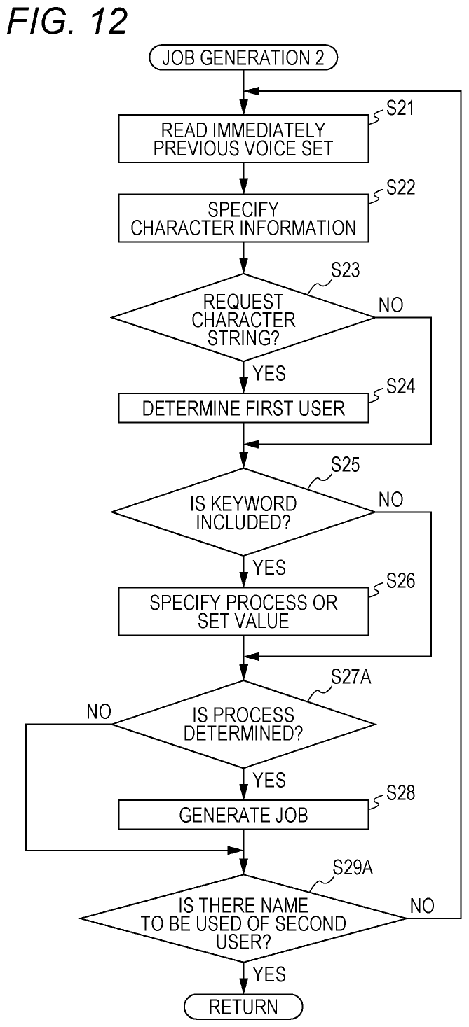

FIG. 12 is a flowchart showing an example of a flow of a job generation process in a first modification. The job generation process in the first modification differs from the job generation process shown in FIG. 9 in that step S27 and step S29 are changed to step S27A and step S29A. Other processing is the same as the processing shown in FIG. 8, and thus description thereof will not he repeated here.

Referring to FIG. 12, the CPU 111 determines whether or not a process is determined in step S27A. When the process is determined, the processing proceeds to step S28, otherwise step S28 is skipped and the processing proceeds to step S29A. In step S28, a job for causing the MFP 100 to execute the process determined in step S27 is generated, and the processing proceeds to step S29A. In step S29A, it is determined whether or not character information includes a name to be used of the second user. When the character information includes the name to be used of the second user, the processing returns to the job control process, otherwise the processing returns to step S21.

In the first modification, the PC 200 generates a request job on the basis of a voice from when the name to be used of the second user is uttered until the second user utters the approval character string. Therefore, since the CPU 201 provided in the PC 200 can narrow down the voices to be processed, the load on the CPU 201 can be reduced as much as possible.

<Second Modification>

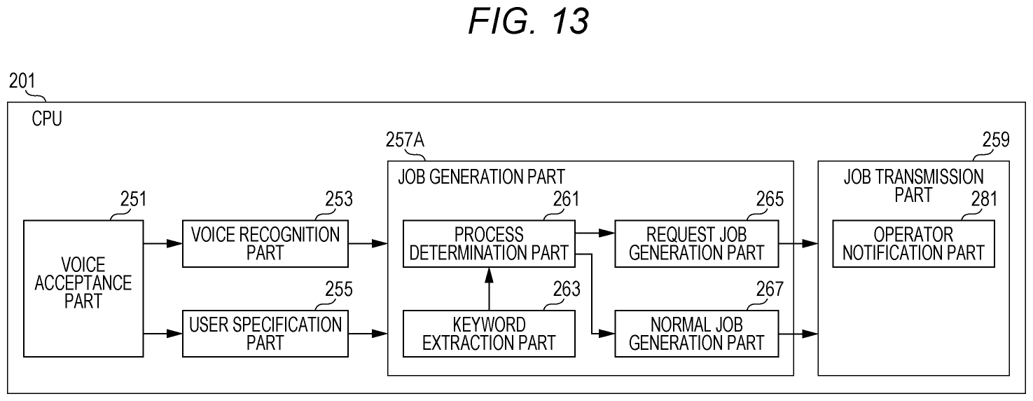

FIG. 13 is a block diagram showing an example of functions of the CPU 201 provided in the PC 200 in a second modification. The functions shown in FIG. 13 are different from the functions shown FIG. 4 in that the job generation part 257 is changed to a job generation part 257A. In the job generation part 257A, a normal job generation part 267 is added to the functions of the job generation part 257. Other functions are the same as the functions shown in FIG. 4, and thus description thereof will not be repeated here.

The normal job generation part 267 outputs a normal generation instruction to the request lob generation part 265 in a case where the request job generation part 265 is inputted with a job from the process determination part 261 but does not generate a request job. When a job is inputted from the process determination part 261 and the normal generation instruction is inputted from the request job generation part 265, the normal job generation part 267 generates a normal job on the basis of the job inputted from the process determination part 261 and one or more voice sets. The normal job is a job other than the request job.

The normal job generation part 267 determines, as an instruction user, a user of user identification information associated, by the voice information, with character information including an instruction character string. The instruction character string is a word for instructing details of a process. For example, “want to do” or “will do”. Further, the normal job generation part 267 may determine the user specified with user identification information having the maximum number of keywords, as the instruction user. In this case, by using a plurality of pieces of character information each including a plurality of keywords used when the process determination part 261 generates a job, keywords corresponding to the user identification information may be accumulated for each piece of user identification information, to obtain the number of keywords for the user identification information. The normal job generation part 267 generates a normal job by setting, in the job inputted from the process determination part 261, an instruction by the instruction user as a start condition for the MFP 100 to execute a process defined by the job. The normal job generation part 267 outputs the normal job to the job transmission part 259. This causes the job transmission part 259 to transmit the normal job to the MFP 100. In the MFP 100, time normal job is stored in the HDD 115 when the normal job is received from the PC 200, and the normal job is set to be an executable state when the instruction user operates the operation part 163.

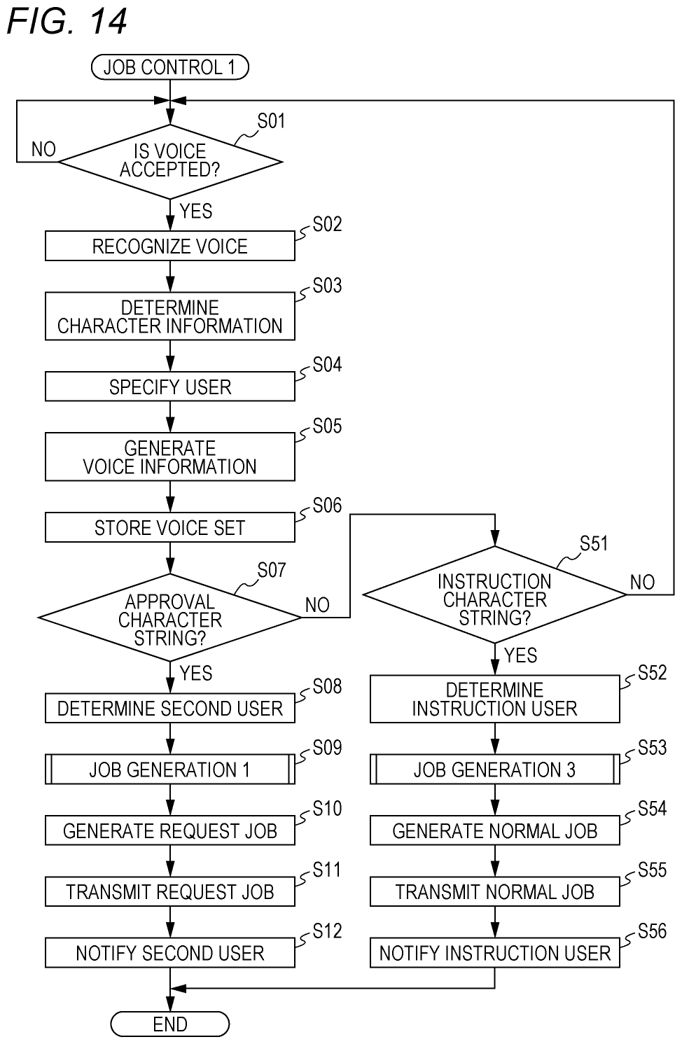

FIG. 14 is a flowchart showing an example of a flow of a job control process in the second modification. The job control process in the second modification is a process executed by the CPU 201 provided in the PC 200, by the CPU 201 executing the job control program stored in the ROM 202, the HDD 204, or the CD-ROM 209A. Referring to FIG. 14, the job control process in the second modification differs from the job control process shown in FIG. 8 in that Step S51 to step S56 are added in a case of NO in step S07. Other processing is the same as the job control process shown in FIG. 8, and thus description thereof will not be repeated here. When the CPU 201 provided in the PC 200 determines in step S07 that the character information does not include the approval character string, the processing proceeds to step S51.

In step S51, it is determined whether or not the character information includes an instruction character string. When the character information includes the instruction character string, the processing proceeds to step S52, otherwise the processing returns to step S01. In step S52, the user who has uttered the instruction character string is determined as the instruction user, and the processing proceeds to step S53. The user specified in step S04 is determined as the instruction user

In step S53, the job generation process in the second modification is executed, and the processing proceeds to step S54. While details of the job generation process in the second modification will be described later, this is a process of generating a job.

In step S54, a normal job is generated, and the processing proceeds to step S55. The normal job is a job in which acceptance of an operation by the instruction user is set as a start condition for causing the MFP 100 to execute a process determined by the normal job. Specifically, the normal job is generated by setting, in the job generated in step S53, acceptance of an operation by the instruction user determined in step S52 as a start condition. In the next step S55, the communication part 205 is controlled to transmit the normal job to the MFP 100, and the processing proceeds to step S56. In step S56, the instruction user is notified of the presence of the normal job, and the processing is ended. Specifically, there is generated an e-mail including a message indicating the presence of a normal job that can be executed in the MFP 100 and having an instruction user's e-mail address set as a destination address, and the communication part 205 is caused to transmit the e-mail.

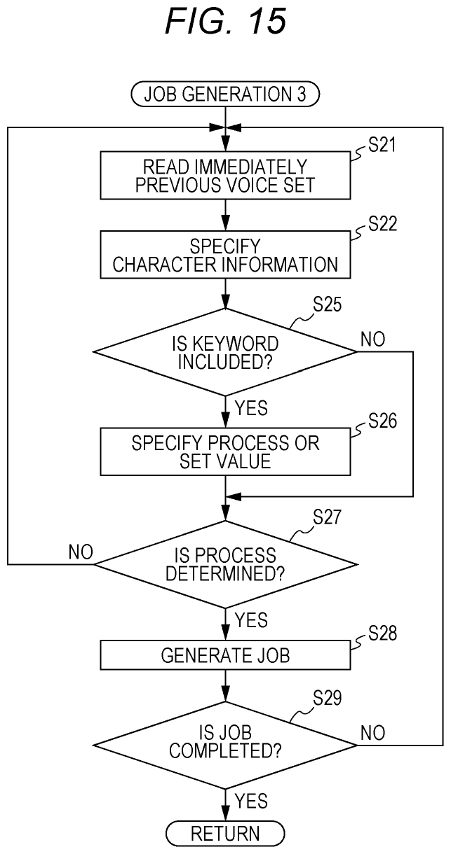

FIG. 15 is a flowchart showing an example of a flow of a job generation process in the second modification. The job generation process in the second modification shown in FIG. 15 differs from the job generation process shown in FIG. 9 in that step S23 and step S24 are deleted. Other processing is the same as the job generation process shown in FIG. 9, and thus description thereof will not be repeated here.

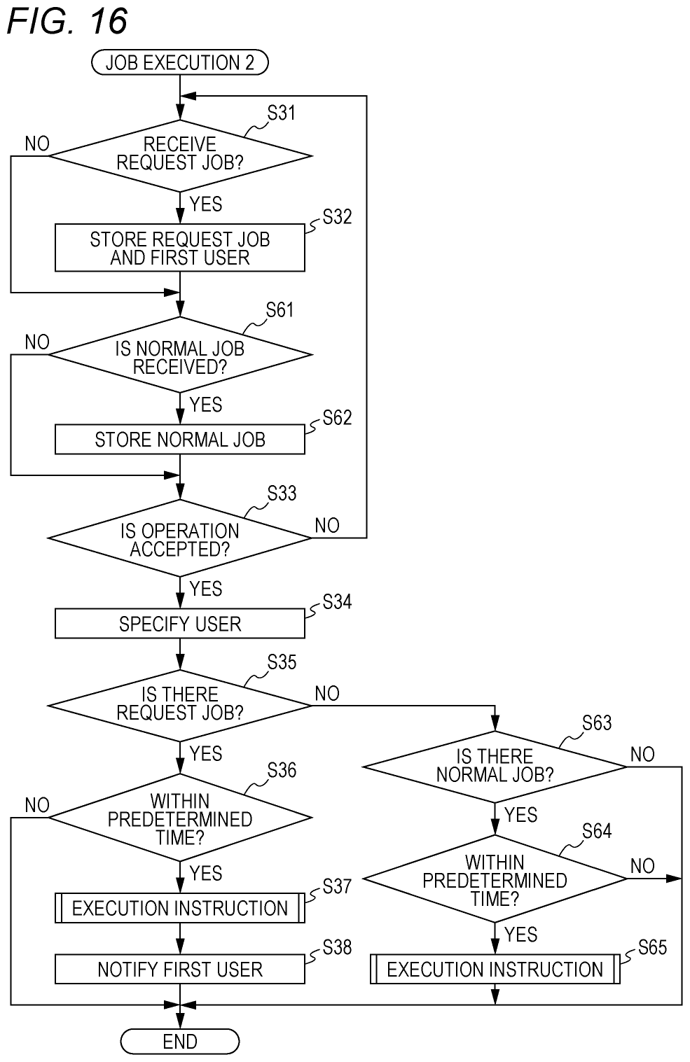

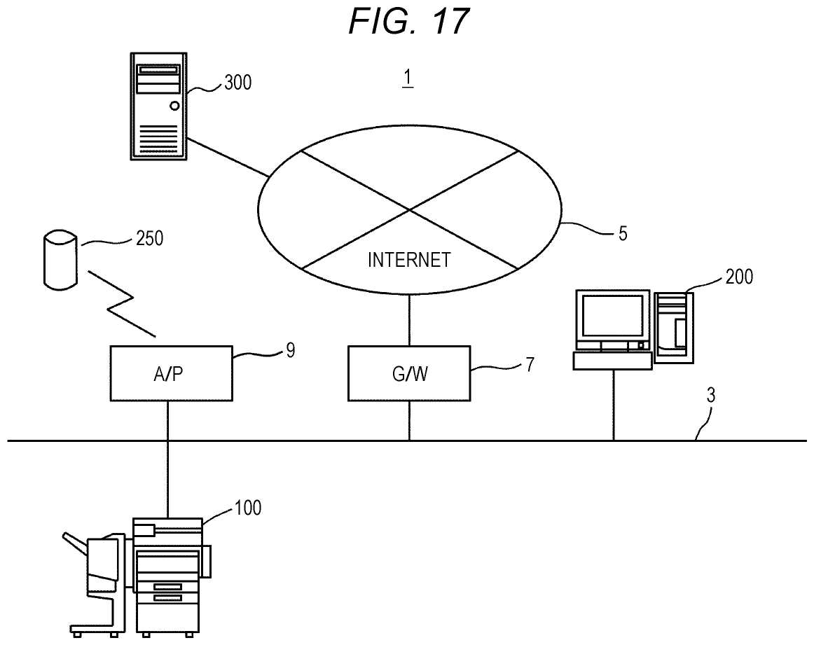

FIG. 16 is a flowchart showing an example of a flow of a job execution process in the second modification. The job execution process in the second modification is a function realized by the CPU 111 provided in the MFP 100, by the CPU 111 executing a job execution program stored in the ROM 113, the HDD 115, or the CD-ROM 118. The job execution program is a part of the job control program. Referring to FIG. 16, the job execution process in the second modification differs from the job execution process shown in FIG. 10 in that steps S61 and S62 are added between step S32 and step S33, and steps S63 to S65 are added in a case of NO in step S35. Other processing is the same as the job execution process shown in FIG. 10, and thus description thereof will not be repeated here.

In step S61, the CPU 111 provided in the MFP 100 determines whether or not a normal job has been received. The CPU 111 controls the communication I/F part 112 to determine whether or not a normal job has been received from the PC 200. When the normal job has been received, the processing proceeds to step S62, otherwise the processing proceeds to step S33. In step S62, the normal job is stored in the HDD 115, and the processing proceeds to step S33.

When the CPU 111 determines in step S35 that the request job is not present, the processing proceeds to step S63. In step S63, it is determined whether or not there is a normal job corresponding to the user specified in step S34. It is determined whether or not the HDD 115 stores a normal job in which an instruction by the specified user is set as a start condition. When the normal job is present, the processing proceeds to step S64, otherwise the processing is ended. In step S64, it is determined whether or not an elapsed time since the normal job has been received is within a predetermined time. When it is within the predetermined time, the processing proceeds to step S65, otherwise the processing is ended. In a case where a predetermined time has passed since the normal job has been received, there is a high probability that the normal job is no longer necessary. Therefore, it is possible to inhibit execution of a normal job that is no longer necessary. In step S65, the execution instruction process shown in FIG. 11 is executed, and the processing is ended. When the execution instruction process is executed, the normal job is set as a processing target, and the normal job is executed.

As described above, in the information processing system 1 in the first embodiment, the PC 200 generates a request job or a normal job on the basis of character information converted from a voice in which the first user and the second user are individually specified. Therefore, the request job or the normal job is generated on the basis of the character information converted from a voice in which the first user and the second user are individually specified. Thus, since the request job or the normal job is generated from a conversation between two or more users, an operation for generating the request job or the normal job can be simplified.

In addition, since the PC 200 generates a request job on the basis of character information converted from a voice in which the first user is specified, a request job that the first user causes the MFP 100 to execute can be determined.

In addition, since the PC 200 generates a request job in which an instruction by the second user is set as a start condition for the MFP 100 to execute, the request job can be generated from a conversation in which the first user requests the second user for work.

Further, since the PC 200 does not generate a request job when character information converted from a voice in which the second user is specified does not indicate a predetermined content, such as a case of including an approval character string, generation of a job can be inhibited when the request from the first user is not accepted by the second user.

In addition, since the MFP 100 associates a request job received from the PC 200 with the first user, the request job can be distinguished from another job.

In addition, since the MFP 100 notifies the first user that a request job has been executed when the request job is executed, the first user can know that the second user has executed the requested work.

In addition, since the MFP 100 sets a request job to an executable state in response to the fact that an operation accepted by the operation part 163 is specified as being inputted by the second user, the second user is not required to input a special operation to the MFP 100 for executing the request job. Therefore, the operation of the second user can be simplified.

Further, since the PC 200 notifies the second user of the presence of the request job, the second user can know the presence of the request job.

In addition, the MFP 100 sets a request job to an executable state in response to the fact that an operation accepted by the operation part 163 is specified, as being an operation of instructing the setting button 501 included in the login screen 500 and being inputted by the second user. Therefore, the second user can execute the request job by instructing the setting button 501 included in the login screen 500, for executing the request job. It is not necessary to select the request job.

In addition, since the PC 200 does not set the request job to an executable state when a predetermined time elapses without the request job being executed, it is possible to inhibit execution of a request job that is no longer necessary.

Further, since the PC 200 in the second modification generates a normal job in which an instruction by the first user as the instruction user is set as a start condition for the MFP 100 to execute, the normal job can be generated from a conversation between the first user and the second user.

In addition, the PC 200 uses a keyword table in which keywords are associated with processes that can be executed by the MFP 100, to determine a process associated with a keyword included in character information converted from a voice in which the first user is specified. Therefore, since the process associated with the keyword included in the character information converted from the voice in winch the first user is specified is determined, the process can be determined from a conversation in which the first user requests the second user for work.

### Second Embodiment

FIG. 17 is a view showing an overall outline of an information processing system in a second embodiment of the present invention. Referring to FIG. 17, an information processing system 1 in the second embodiment includes an MFP 100, a PC 200, and a smart speaker 250. The MFP 100 in the second embodiment functions as an image processing apparatus similarly to the MFP 100 in the first embodiment, and also functions as an information processing apparatus.

The smart speaker 250 includes a microphone, a speaker, and a wireless LAN interface. The smart speaker 250 functions as an output device that generates sound front the speaker and also functions as an input device that accepts a voice collected by the microphone. An access point (AP) 9 is a relay device having a wireless communication function, and is connected to a network 3. The smart speaker 250 is connected to the network 3 by communicating with the AP 9. Therefore, the smart speaker 250 can communicate with the MFP 100 and the PC 200.

A gateway (G/W) device 7 is connected to the network 3 and connected to the Internet 5. The gateway device 7 relays the network 3 and the Internet 5. A cloud server 300 is connected to the Internet 5. Therefore, each of the MFP 100, the PC 200, and the smart speaker 250 can communicate with the cloud server 300 via the gateway device 7.

The cloud server 300 functions as an artificial intelligence (AI) assistant for the swat speaker 250. In the smart speaker 250, the AI assistant provided in the cloud server 300 is registered in advance. The smart speaker 250 converts a voice collected by the microphone into voice data that is electronic data, and transmits to the cloud server 300. Further, the smart speaker 250 converts electronic data transmitted from the cloud server 300 into a voice and outputs the voice from the speaker.

The cloud server 300 uses the smart speaker 250 as a user interface to recognize a voice of the user collected by the smart speaker 250, and converts into character information.

Further, the cloud server 300 has a user identification function. In the cloud server 300, a voice print of a user who operates the smart speaker 250 is registered in advance in association with the smart speaker 250. The cloud server 300 compares the voice collected by the smart speaker 250 with the registered user's voiceprint, and identifies the user from the voice. As described above, the cloud server 300 identifies the user who has uttered the voice on the basis of the voice collected by the smart speaker 250.

In addition, an application program for controlling the MFP 100 is installed in the cloud server 300, and transmits, to the MFP 100, voice information including: character information converted from the user's voice; and user identification information of the user who has uttered the voice.

Note that operations of the AI assistant of the cloud server 300 and the application program registered in the cloud server 300 are not limited to the operations described above, and other operations may be performed.

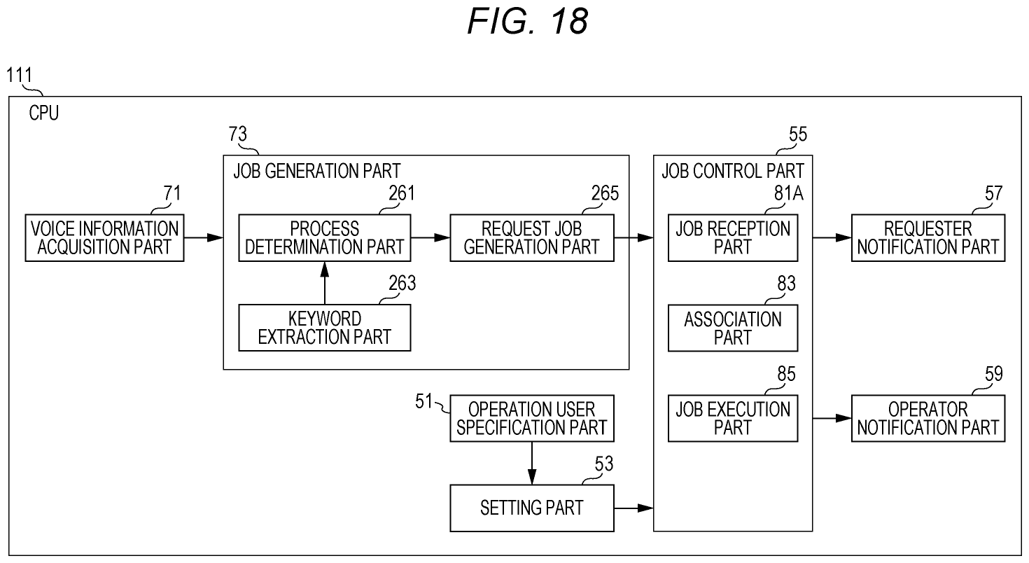

FIG. 18 is a block diagram showing an example of functions of a CPU provided in the MFP in the second embodiment. The functions shown in FIG. 18 are functions realized by a CPU 111 provided in the MFP 100, by the CPU 111 executing a job control program stored in an ROM 113, an HDD 115, or a CD-ROM 118. Referring to FIG. 18, differences from the functions shown in FIG. 6 are that a voice information acquisition part 71, a job generation part 73, and an operator notification part 59 are added, and the job reception part 81 is changed to a job reception part 81A. Other functions are the same as the functions shown in FIG. 6, and thus description thereof will not be repeated here.

The voice information acquisition part 71 acquires voice information from the cloud server 300. Specifically, the voice information acquisition part 71 controls a communication I/F part 112 to acquire voice information that is received by the communication I/F part 112 from the cloud server 300. The voice information acquisition part 71 outputs the voice information to the job generation part 73A.

The job generation part 73 has a function similar to that of the job generation part 257 of the CPU 201 provided, in the PC 200 in the first embodiment. That is, on the basis of a plurality of pieces of voice information received from the cloud server 300, a request job is generated and, a first user is determined. The job generation part 73 outputs the request job and user identification information of the first user to a job control part 55. The job reception part 81A of the job control part 55 accepts the request job and the user identification information of the first user that are outputted from the job generation part 73.

The operator notification part 59 has a function similar to that of the operator notification part 281 of the CPU 201 provided in the PC 200 in the first embodiment. That is, when a set of the request job and the user identification information of the first user is transmitted to the MFP 100, the operator notification part 59 notifies a second user that the request job can be executed with the MFP 100.

In the information processing system 1 in the second embodiment, the cloud server 300 has a part of the functions of the PC 200 of the information processing system 1 in the first embodiment, and the MFP 100 has another part of the functions of the PC 200. Therefore, since it is not necessary to use the PC 200, the system can be simplified.

Note that the smart speaker 250 may have the function of the cloud server 300. That is, when the smart speaker 250 has voice recognition and voice authentication functions, the MFP 100 can acquire voice information from the smart speaker 250. In this case, since the cloud server 300 is unnecessary, the system configuration can be simplified.

<Third Modification>

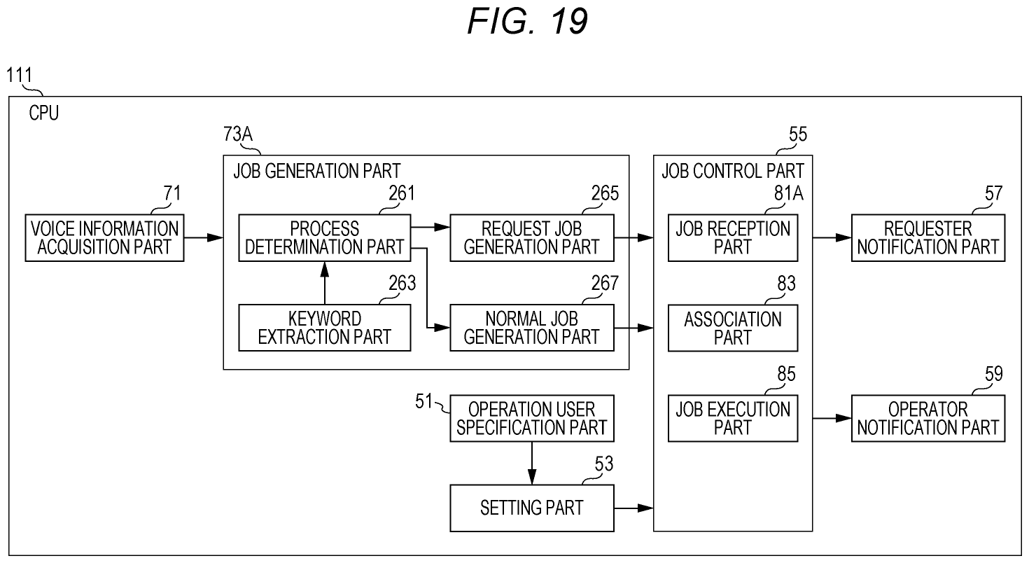

FIG. 19 is a block diagram showing an example of functions of the CPU 111 provided in the MFP 100 according to a third modification. The functions shown in FIG. 19 are different from the functions shown in FIG. 18 in that the job generation part 73 is changed to a job generation part 73A. In the job generation part 73A, a normal job generation part 267 is added to the functions of the job generation part 73. Other functions are the same as the functions shown in FIG. 18, and thus description thereof will not be repeated here.

The normal job generation part 267 has a function similar to that of the normal job generation part 267, which is one of the functions of the CPU 201 provided in the PC 200 in the second modification illustrated in FIG. 13. Therefore, the description will not be repeated here.

<Fourth Modification>

The MFP 100 in the second embodiment may include a microphone. In this case, the CPU 111 provided in the MFP 100 includes the voice acceptance part 251, the voice recognition part 253, and the user specification part 255 among the functions of the CPU 201 provided in the PC 200 in the second modification illustrated in FIG. 13. This eliminates necessity of the smart speaker 250 and the cloud server 300, enabling simplification of the system configuration.

<Fifth Modification>

In the second embodiment, voice information including: character information converted from a user's voice; and user identification information of the user who has uttered the voice, is transmitted from the cloud server 300 to the MFP 100. In a fifth modification, the voice information includes a user's voice and user identification information of the user who has uttered the voice. In this case, the voice information may be directly transmitted from the smart speaker 250 to the MFP 100, or the voice information may be transmitted to the MFP 100 via the cloud server 300. In this case, the CPU 111 provided in the MFP 100 includes the voice recognition part 253 among the functions of the CPU 201 provided in the PC 200 in the second modification illustrated in FIG. 13.

As described above, in the information processing system 1 in the second embodiment, the MFP 100 generates a request job or a normal job on the basis of character information converted from a voice in which the first user and the second user are individually specified. Therefore, since the request job or the normal job is generated on the basis of the character information converted from a voice in which the first user and the second user are individually specified, the request job or the normal job is generated from conversation between two or more users. Accordingly, the operation for generating the request job or the normal job can be simplified.

In addition, since the MFP 100 generates a request job on the basis of character information converted from a voice in which the first user is specified, a request job that the first user causes the MFP 100 to execute can be determined.

In addition, since the MFP 100 generates a request job in which an instruction by the second user is set as a start condition for the MFP 100 to execute, the request job can be generated from a conversation in which the first user requests the second user for work.

Further, since the MFP 100 does not generate a request job when character information converted from a voice in which the second user is specified does not indicate a predetermined content, generation of a job can be inhibited when the request from the first user is not accepted by the second user.

In addition, since the MFP 100 associates a request job with the first user, the request job can be distinguished from another job.

In addition, since the MFP 100 notifies the first user that a request job has been executed when the request job is executed, the first user can know that the second user has executed the requested work.

In addition, since the MFP 100 sets a request job to an executable state in response to the fact that an operation accepted by the operation part 163 is specified as being inputted by the second user, the second user is not required to input a special operation to the MFP 100 for executing the request job. Therefore, the operation of the second user can be simplified.

Further, since the MFP 100 notifies the second user of the presence of a request job, the second user can know the presence of the request job.

In addition, the MFP 100 sets a request job to an executable state in response to the fact that an operation accepted by the operation part 163 is specified as being an operation of instructing the setting button 501 included in the login screen 500 and being inputted by the second user. Therefore, the second user can execute the request job by instructing the setting button 501 included in the login screen 500, for executing the request job. This eliminate necessity of an operation of selecting the request job.

In addition, since the MFP 100 does not set a request job to an executable state when a predetermined time elapses without the request job being executed, it is possible to inhibit execution of a request job that is no longer necessary.

In addition, since the MFP 100 in the third modification generates a normal job in which an instruction by the first user is set as a start condition for the MFP 100 to execute, the normal job can be generated from a conversation between the first user and the second user.

In addition, the MFP 100 uses a keyword table in which keywords are associated with processes that can be executed by the MFP 100, to determine a process associated with a keyword included in character information converted from a voice in which the first user is specified. Therefore, since the process associated with the keyword included in character information converted from a voice in which the first user is specified is determined, the process can be determined from a conversation between the first user and the second user.

Although embodiments of the present invention have been described and illustrated in detail, the disclosed embodiments are made for purposes of illustration and example only and not limitation. The scope of the present invention should be interpreted by terms of the appended claims, and it is intended to include all modifications within the meaning and scope equivalent to the claims.

What is claimed is:

1. An information processing system comprising:
a voice collecting device that collects a voice; and
an information processing apparatus capable of generating a job,
wherein either of the voice collecting device and the information processing apparatus comprises
a hardware processor that specifies a user who has uttered, and
the hardware processor of the information processing apparatus generates, as the job, based on information obtained from a voice in which a first user and a second user are individually specified by the hardware processor, a request job that the first user has requested the second user to execute.

2. The information processing system according to claim 1, wherein the hardware processor generates the request job when the information obtained from a voice in which the second user is specified indicates a content of approval.

3. The information processing system according to claim 1, wherein the hardware processor sets the request job to be executable by the second user.

4. The information processing system according to claim 1, wherein the hardware processor generates the request job based on the information obtained, from a voice in which the first user is specified.

5. The information processing system according to claim 1, wherein when the information obtained from a voice in which the second user is specified does not indicate a content of approval, the hardware processor generates a normal job different from the request job, as the job.

6. The information processing system according to claim 1, wherein the hardware processor of the information processing apparatus notifies the first user that the request job has been executed when the request job is executed.

7. The information processing system according to claim 1, wherein the hardware processor of the information processing apparatus notifies the second user of the request job.

8. The information processing system according to claim 1, wherein the hardware processor specifies a user who has uttered, by using a voice print of a user registered in advance.

9. The information processing system according to claim 1, further comprising
an image processing apparatus that executes the job,
wherein the hardware processor uses processing-related information in which a keyword is associated with a process executable by the image processing apparatus, to determine the process associated with the keyword included in the information obtained from a voice in which the first user and the second user are individually specified.

10. The information processing system according to claim 9, wherein, after the request job is generated, the image processing apparatus does not execute the request job in a case where a predetermined time elapses without the request job being executed.

11. The information processing system according to claim 1,
wherein the information processing apparatus is an image processing apparatus that executes the job, and
the hardware processor uses processing-related information in which a keyword is associated with a process executable by the information processing apparatus, to determine the process associated with the keyword included in the information obtained from a voice in which the first user and the second user are individually specified.

12. The information processing system according to claim 11, wherein, after the request job is generated, the information processing apparatus does not execute the request job in a case where a predetermined time elapses without the request job being executed.

13. An information processing apparatus comprising
a hardware processor that:
acquires voice information in which user identification information for identifying a user who has uttered is associated with information obtained from a voice; and
generates, based on the information individually associated with a first user and a second user by the voice information that has been acquired, a request job that the first user has requested the second user to execute

14. The information processing apparatus according to claim 13, wherein the hardware processor generates the request job when the information associated with the second user by the voice information indicates a content of approval.

15. The information processing apparatus according to claim 13, wherein the hardware processor sets the request job to be executable by the second user.

16. The information processing apparatus according to claim 13, wherein the hardware processor generates the request job based on the information associated with the first user by the voice information.

17. The information processing apparatus according to claim 13, wherein the hardware processor generates a normal job that is different from the request job, when the information associated with the second user by the voice information does not indicate a content of approval.

18. The information processing apparatus according to claim 13, wherein the hardware processor uses processing-related information in which a keyword is associated with a process executable by an image processing apparatus that executes the request job, to determine the process associated with the keyword included in the information individually associated with the first user and the second user by the voice information.

19. The information processing apparatus according to claim 13,
wherein the information processing apparatus is an image processing apparatus that executes the request job, and
the hardware processor uses processing-related information in which a keyword is associated with a process executable by an own apparatus, to determine the process associated with the keyword included in the information individually associated with the first user and the second user by the voice information.

20. A job control method to be executed by an information processing system,
wherein the information processing system comprises:
a voice collecting device that collects a voice; and
an information processing apparatus capable of generating a job, and
the method comprises:
causing either of the voice collecting device and the information processing apparatus to execute specifying a user who has uttered; and
causing the information processing apparatus to execute, based on information obtained from a voice in which a first user and a second user are individually specified in the user specifying, generating, as the job, a request job that the first user has requested the second user to execute.

21. The job control method according to claim 20, wherein the job generating includes generating the request job when the information obtained from a voice in which the second user is specified indicates a content of approval.

22. The job control method according to claim 20, wherein the job generating sets the request job to be executable by the second user.

23. The job control method according to claim 20, wherein the job generating generates the request job based on the information obtained from a voice in which the first user is specified.

24. The job control method according to claim 20, wherein the job generating generates a normal job that is different from the request job as the job, when the information obtained from a voice in which the second user is specified does not indicate a content of approval.

25. The job control method according to claim 20,
wherein the information processing system further comprises an image processing apparatus that executes the job, and
the job generating uses processing-related information in which a keyword is associated with a process executable by the image processing apparatus, to determine the process associated with the keyword included in the information obtained from a voice in which the first user and the second user are individually specified.

26. The job control method according to claim 20,
wherein the information processing apparatus is au image processing apparatus that executes the job, and
the job generating uses processing-related information in winch a keyword is associated with a process executable by the information processing apparatus, to determine the process associated with the keyword included in the information obtained from a voice in which the first user and the second user are individually specified.

27. A non-transitory recording medium storing a computer readable job control program to be executed by a computer that controls an information processing apparatus, the job control program causes the computer to execute:
acquiring voice information in which user identification information for identifying a user who has uttered is associated with information obtained from a voice; and
generating, based on information individual, associated, with a first user and a second user by the voice information that has been acquired, a request job that the first user has requested the second user to execute.

28. The non-transitory recording medium storing a computer readable job control program according to claim 27,
wherein the job generating includes generating the request job when the information associated with the second user by the voice information indicates a content of approval.

29. The non-transitory recording medium storing a computer readable job control program according to claim 27, wherein the job generating sets the request job to be executable by the second user.

30. The non-transitory recording medium storing a computer readable job control program according to claim 27, wherein the job generating generates the request job based on the information associated, with the first user by the voice information.

31. The non-transitory recording medium storing a computer readable job control program according to claim 27, wherein the job generating includes generating a normal job that is different from the request job when the information associated with the second user by the voice information does not indicate a content of approval.

32. The non-transitory recording medium storing a computer readable job control program according to claim 27, wherein the job generating uses processing-related information in which a keyword is associated with a process executable by an image processing apparatus that executes the request job, to determine the process associated with the keyword included in the information individually associated with the first user and the second user by the voice information.

33. The non-transitory recording medium storing a computer readable job control program according to claim 27,
wherein the information processing apparatus is an image processing apparatus that executes the request job, and
the job generating uses processing-related information in which a keyword is associated with a process executable by the information processing apparatus, to determine the process associated with the keyword included in the information individually associated with the first user and the second user by the voice information.
